(19) United States
(12) Patent Application Publication
(10) Pub. No.: US 2016/0202109 A1
(43) Pub. Date: Jul. 14, 2016

(54) Threshold measuring arrangement

(71) Applicant: Vega Grieshaber KG, Wolfach (DE)

(72) Inventors: Gerd Ohmayer, Haslach (DE); Frank Becherer, Neuried-Ichenheim (DE)

(21) Appl. No.: 14/948,491

(22) Filed: Nov. 23, 2015

(30) Foreign Application Priority Data
Jan. 14, 2015 (EP) 15 151 201.9

(51) Int. Cl. G01F 23/296

(52) U.S. Cl. CPC G01F 23/2966

(57) ABSTRACT

A threshold measuring arrangement with a modular design, comprising a threshold sensor arranged at the front of a system housing, an electronic housing arranged in the system housing with a measuring electronic, which is connected to the threshold measuring sensor, as well as an extension tube arranged at the system housing to arrange the threshold sensor in a container.

### CROSS REFERENCE TO RELATED APPLICATIONS

This patent application claims priority to European Patent Application 15 151 201.9, filed on Jan. 14, 2015.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The invention relates to a threshold measuring arrangement.

2. Background of the Invention

Various threshold measuring arrangements are known from prior art, in which at a measuring tube, at the front, a threshold sensor is arranged, for example a Piezo-electrically driven vibration sensor. At the rear, a measuring electronic is fastened in an appropriate electronic housing at the measuring tube, connected via a measuring line to the threshold sensor.

Threshold measuring arrangements are used in many fields of processing technology, for example in the food industry, pharmaceutical industry, or the chemical industry for monitoring thresholds of liquids or bulk goods. For this purpose, the threshold measuring arrangements of prior art are equipped with a threshold sensor, for example a fork resonator provided with a Piezo-electric or electromagnetic drive, arranged at the level of the threshold to be monitored. In many cases the respective threshold sensors are introduced from the top of a container, and positioned via a measuring tube, at which they are fastened, at the level of the threshold to be monitored.

The arrangement of such a threshold sensor according to prior art at several fill levels occurs via a so-called locking screw, i.e. a clamping device clamping the measuring tube in a sealing fashion and connected to a container. Due to the fact that an appropriate clamping device, on the one hand, must ensure the sealing of the container even at high pressures and, on the other hand, thorough cleaning, for example in hygiene-critical applications, e.g. in the food, pharmaceutical, or chemical sector, it shows a comparatively complex construction with several clamping sections and seals arranged therebetween. Further, the design known from prior art requires, due to the prefabricated length of the threshold measuring arrangement, a differently long section of the measuring tube as well as the measuring electronic arranged thereat outside the container, depending on the desired positioning of the threshold sensor inside the container.

In the threshold measuring arrangements of prior art, on the one hand the expensive clamping arrangement for placing the threshold measuring arrangements in the container, and on the other hand the large space required of the threshold measuring arrangement outside the container are considered disadvantageous.

The objective of the present invention is to provide a threshold measuring device not showing any of these disadvantages.

This objective is attained in a threshold measuring arrangement showing the features as described herein.

### BRIEF SUMMARY OF THE INVENTION

In a preferred embodiment, a threshold measuring arrangement with a modular design, comprising a threshold sensor arranged at the front of a system housing, an electronic housing arranged in the system housing with a measuring electronic, which is connected to the threshold sensor, as well as an extension tube arranged at the system housing to arrange the threshold sensor in a container.

In another preferred embodiment, the threshold measuring arrangement according to claim 1, wherein the system housing comprises a housing jacket made from sheet metal.

In another preferred embodiment, the threshold measuring arrangement according to claim 2, wherein the housing jacket and the threshold sensor are welded to each other.

In another preferred embodiment, the threshold measuring arrangement according to claim 1, further comprising wherein the system housing comprises at the rear an end cap with an opening.

In another preferred embodiment, the threshold measuring arrangement according to claim 4, wherein the end cap is embodied as a swivel part.

In another preferred embodiment, the threshold measuring arrangement according to claim 4, wherein the end cap is welded to the housing jacket.

In another preferred embodiment, the threshold measuring arrangement according to claim 1, wherein the extension tube is screwed or adhered to the system housing.

In another preferred embodiment, the threshold measuring arrangement according to claim 1, wherein the extension tube is welded to the system housing.

In another preferred embodiment, the threshold measuring arrangement according to claim 1, wherein the system housing is embodied rotationally symmetrical.

In another preferred embodiment, the threshold measuring arrangement according to claim 1, wherein the system housing is surface treated, particularly polished or coated.

In another preferred embodiment, the threshold measuring arrangement according to claim 4, wherein the extension tube is screwed, welded, or adhered to the end cap.

### BRIEF DESCRIPTION OF THE DRAWINGS

FIG. 1 is a line drawing evidencing a longitudinal cross-section through a threshold measuring arrangement with a modular design.

FIG. 2 is a line drawing evidencing a perspective view of the threshold measuring arrangement of FIG. 1.

### DETAILED DESCRIPTION OF THE INVENTION

A threshold measuring arrangement according to the invention shows a modular design, with a threshold sensor being arranged at the front of the system housing. An electronic housing with a measuring electronic is arranged in said system housing, with further an extension tube being arranged at the system housing to fasten the threshold sensor in a container.

By a threshold sensor according to the invention with a modular design, a compact construction of the threshold measuring arrangement can be yielded using largely standardized components. In particular, by the arrangement of the threshold sensor at the system housing as well as the measuring electronic in the system housing, the structural space required by the threshold measuring arrangement outside the container can be reduced to a minimum. Ideally it is possible by the design according to the invention to size the extension tube, placed at the rear at the system housing, to the length required for the arrangement of the threshold sensor at the threshold to be monitored and thus to require outside the container almost no structural space at all. Further, by the arrangement according to the invention the option is provided to connect the extension tube directly to the container, for example by way of welding, so that any expensive pressure-tight clamping arrangements can be waived.

An easy and cost-effective design of the system housing can be achieved if it features a housing jacket made from sheet metal. Here, the housing jacket may be embodied for this purpose, for example, as a deep-drawn part, a hydroformed part, or a sheet metal part with rounded longitudinal welding seams. This way, via cost-effective production methods, a light and yet stable system housing can be constructed.

Preferably the housing jacket is adhered, soldered, or welded to the threshold sensor at the front. This way the threshold sensor, which for example may be embodied as a vibration sensor, can be connected cost-effectively and without the use of seals to the system housing. A fastening of the threshold sensor at the system housing, free from seals and yet diffusion-resistant, is particularly important in applications sensitive with regards to hygiene, such as the food, the pharmaceutical, or the chemical sector.

A welding seam between the housing jacket and the threshold sensor can therefore be particularly sanded or polished so that no gaps or other potential sites for depositing germs or the like can develop by the connection of the housing jacket to the threshold sensor.

An end cap with a cable conduit is preferably arranged at the rear at the system housing. The end cap may be formed as a swivel part, for example, and preferably soldered or welded to the housing jacket.

By embodying the end cap as a swivel part, it can be used very well as a connection element to the extension tube arranged at the rear. Any connection between the end cap and the housing jacket can be produced, for example, by way of welding or soldering.

The extension tube can be screwed and/or adhered to the system housing, preferably to the end cap. Additionally or alternatively the extension tube may also be welded to the system housing, preferably the end cap.

A selection of connection techniques between the extension tube and the system housing occurs generally based on the process requirements with regards to freedom from gaps and diffusion resistance. A screw-connection between the extension tube and, for example, the end cap allows a more flexible use of the threshold measuring arrangement, because it can be used for different thresholds by exchanging the extension tube, for example. If high diffusion resistance and/or freedom from gaps of the threshold measuring device are required, a welded connection between, for example, the end cap and the extension tube represents a good option for generating a hermetically sealed encapsulation and optimal way for cleaning the threshold measuring arrangement.

A particularly good application of the threshold measuring arrangement in fields critical with regards to hygiene can be yielded when the system housing is embodied rotationally symmetrical. By a rotationally symmetric embodiment of the system housing, i.e. particularly the housing jacket, the end cap, and the transitional area to the threshold sensor, here an arrangement can be generated, which is particularly free from gaps or undercuts and shows a surface easily provided with surface treatments, if applicable. In this context it may be useful, for example, to polish the system housing and/or to coat it.

In an arrangement of the measuring electronic and the electronic housing, respectively, inside the system housing, which is then directly placed abutting the threshold sensor in the processing environment, it may be necessary that the system housing or the electronic housing is provided with suitable cooling to protect the electronic housed therein. This may particularly be necessary when the electronic used in the long run cannot withstand the permanently existing processing temperatures and/or any temperatures up to 150° C. temporarily existing during the cleaning of the container and given in the threshold measuring arrangement.

### DETAILED DESCRIPTION OF THE FIGURES

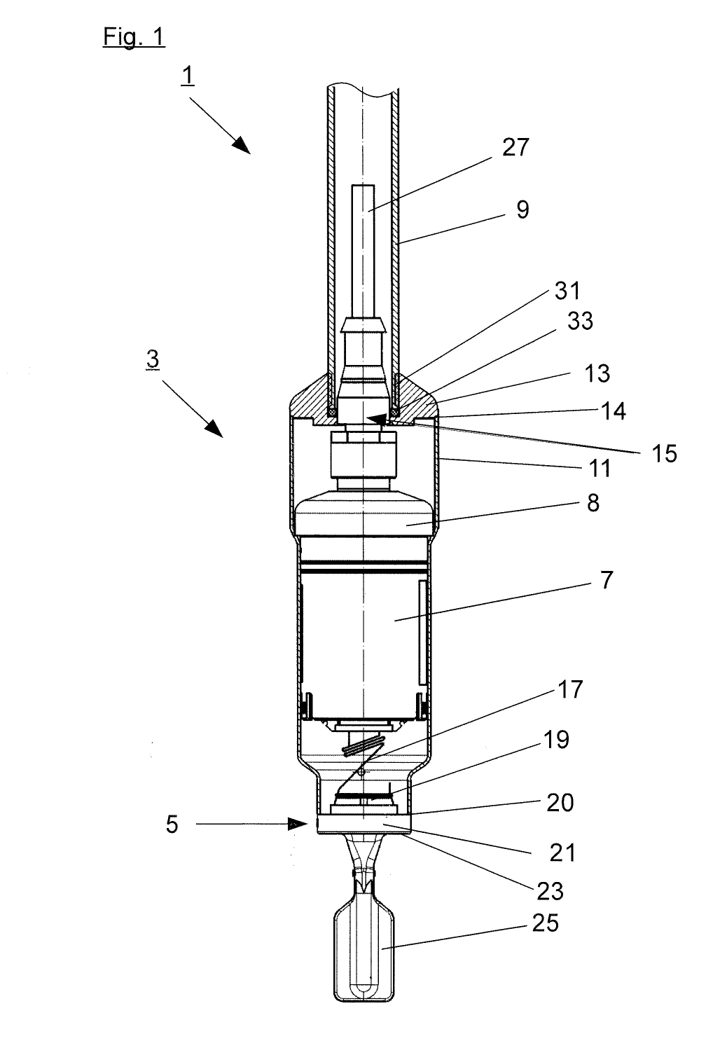

FIG. 1 shows a longitudinal cross-section through a threshold measuring arrangement 1 according to the present application.

A threshold sensor 5 is arranged via a circumferential welding seam 20 at the front of a system housing 3. The system housing 3 shows a tubular housing jacket 11, which in the present exemplary embodiment is made from a thin-walled sheet metal, for example a deep-drawn part, hydroformed part, or a sheet metal part with rounded longitudinal welding seams. The housing jacket 11 is welded at the front side circumferentially to a transitional part 21 of the threshold sensor 5, for example via a circumferential welding seam. A membrane 23 is arranged at the transitional part 21, aligned perpendicular in reference to a longitudinal axis of the system housing, which can be excited to oscillate by a drive 19 arranged at the interior, for example a Piezo-electric drive. Two mechanic oscillators 25 in the form of paddles are arranged at the exterior of the membrane 23. Due to the oscillation of the membrane 23, excited by the drive 19, the mechanic oscillators 25 vibrate with a certain frequency, depending on the ambient medium,

so that by a measurement of this resonance frequency of the mechanic oscillator 25 it can then be concluded, for example, if it oscillates in air or is covered by a liquid or bulk goods. This way a threshold can be detected.

The drive 19 is connected via a so-called flexible conductor 17 or another suitable electric connection to a measuring electronic, which in the present case is arranged in an electronic housing 7. The electronic housing 7 is accepted in the present exemplary embodiment in the radial direction in a form-fitting fashion in the system housing 3 and thus arranged in a centered fashion. In the axial direction the electronic housing 7 shows at the rear a lid 8, which abuts to a tapering of the system housing 3, which therefore represents a counter-bearing for the electronic housing 7 in the axial direction A. Alternatively or additionally, the electronic housing 7 may also be fixed by way of adhesion or injection molding in the system housing 3.

At the rear, the system housing 3 is closed by an end cap 13, which is welded circumferentially to the housing jacket 11. A welding seam or soldering seam 14 between the end cap 13 and the housing jacket 11 is also sanded or polished in the present exemplary embodiment, so that a gap-free and diffusion-resistant connection is yielded.

In the present exemplary embodiment the end cap 13 is essentially cage-like and embodied as a swivel part, showing an opening 15 in the axial direction A for passing a measuring cable 27. This opening 15 can simultaneously provide strain relief for the measuring cable 27, which can be achieved, for example, by way of clamping.

In the present exemplary embodiment, the end cap 13 shows an internal thread, which is formed corresponding to an external thread formed at the extension tube 9. A screw connection 31 formed this way between the end cap 13 and the extension tube 9 is here embodied such that a seal 33 arranged in the axial direction A at the bottom in the interior thread, for example an O-ring, is compressed during the screw-connection of the extension tube 9 with the end cap 13 by the screwed-in extension tube 9, and this way a clamping effect develops upon the measuring cable 27. This way the measuring electronic in the electronic housing 7 can be provided with strain relief in reference to the measuring cable 27.

As an alternative to the screw connection 31, the extension tube 9 may also be welded to the end cap 13. This way an easy way to exchange the extension tube 9 and thus a variation in length of the present threshold measuring arrangement 1 is prevented; however, a hermetically encapsulated threshold measuring arrangement 1 can be generated without any gaps or seals within the processing environment, which is therefore optimally suitable for hygiene-critical applications.

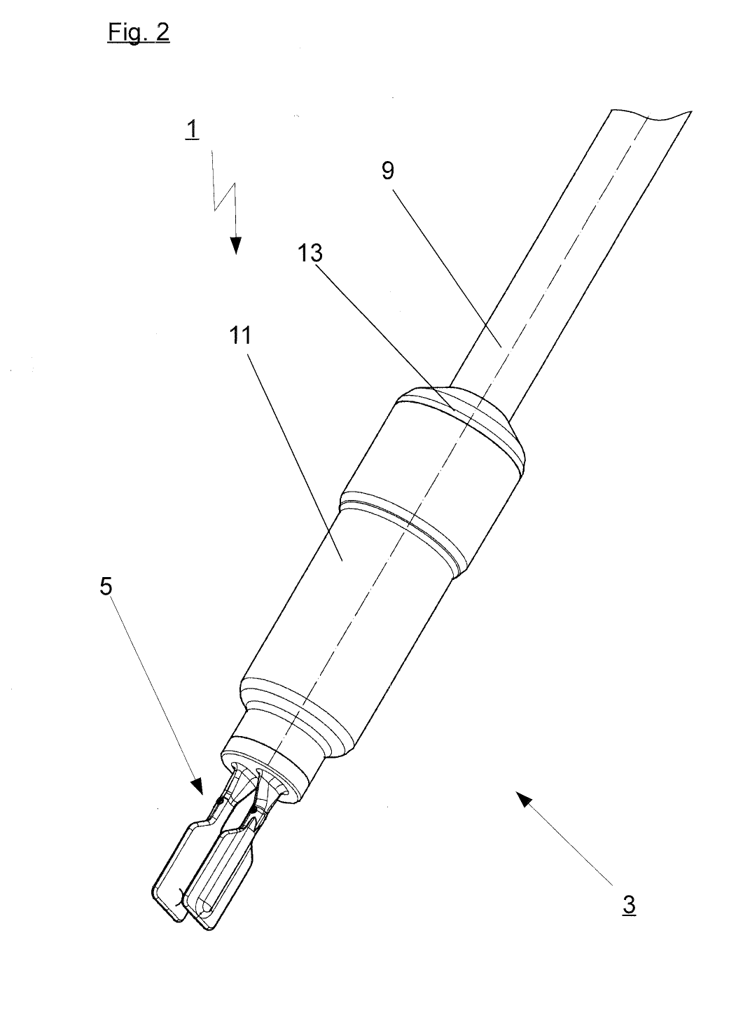

FIG. 2 shows a perspective illustration of the threshold measuring arrangement 1 of FIG. 1.

The view clearly shown in FIG. 2 is a rotationally symmetrical embodiment of the system housing 3. The system housing 3 is this way particularly easily subjected to surface treatments, such as polishing or coating, so that also the surface features of the housing can be optimally adjusted to the desired purpose for use.

In a particularly preferred embodiment, both the exterior components of the threshold sensor 5 as well as the exterior surfaces of the system housing 3, in the present case the housing jacket 11 as well as the end cap 13, are made from stainless steel and thus particularly well suited for hygiene-critical applications.

Due to the fact that the measuring electronic is arranged inside the system housing 3, the extension tube 9 arranged at the rear of the system housing 3 can very easily be cut to length and, for example, be welded in a flange or directly into the container wall. This way, any parts of the threshold measuring arrangement 1 arranged outside the container are completely avoided and only the measuring cable 27 needs to be guided to a measuring station or an appropriate processing device.

### LIST OF REFERENCE NUMBERS

1 Threshold measuring device

3 System housing

5 Threshold sensor

7 Electronic housing

8 Lid

9 Extension tube

11 Housing jacket

13 End cap

14 Welding seam/soldering seam

15 Opening

17 Flexible conduit

19 Drive

20 Welding seam/soldering seam

21 Transitional part/welding edge

23 Membrane

25 Oscillator

27 Measuring cable

31 Screw connection

33 Seal

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A threshold measuring arrangement with a modular design, comprising a threshold sensor arranged at the front of a system housing, an electronic housing arranged in the system housing with a measuring electronic, which is connected to the threshold sensor, as well as an extension tube arranged at the system housing to arrange the threshold sensor in a container.

2. The threshold measuring arrangement according to claim 1, wherein the system housing comprises a housing jacket made from sheet metal.

3. The threshold measuring arrangement according to claim 2, wherein the housing jacket and the threshold sensor are welded to each other.

4. The threshold measuring arrangement according to claim 1, further comprising wherein the system housing comprises at the rear an end cap with an opening.

5. The threshold measuring arrangement according to claim 4, wherein the end cap is embodied as a swivel part.

6. The threshold measuring arrangement according to claim 4, wherein the end cap is welded to the housing jacket.

7. The threshold measuring arrangement according to claim 1, wherein the extension tube is screwed or adhered to the system housing.

8. The threshold measuring arrangement according to claim 1, wherein the extension tube is welded to the system housing.

9. The threshold measuring arrangement according to claim 1, wherein the system housing is embodied rotationally symmetrical.

10. The threshold measuring arrangement according to claim 1, wherein the system housing is surface treated, particularly polished or coated.

11. The threshold measuring arrangement according to claim 4, wherein the extension tube is screwed, welded, or adhered to the end cap.
